(19) United States
(12) Patent Application Publication
(10) Pub. No.: US 2017/0177717 A1
(43) Pub. Date: Jun. 22, 2017

(54) RATING A LEVEL OF JOURNALISTIC DISTORTION IN NEWS MEDIA CONTENT

(71) Applicant: The Knife, LLC, Clifton Park, NY (US)

(72) Inventor: Keith A. Raniere, Clifton Park, NY (US)

(21) Appl. No.: 15/387,450

(22) Filed: Dec. 21, 2016

Related U.S. Application Data
(60) Provisional application No. 62/270,125, filed on Dec. 21, 2015.

(51) Int. Cl. G06F 17/30

(52) U.S. Cl. CPC G06F 17/30705; G06F 17/30728; G06F 17/30867; H04L 67/20

(57) ABSTRACT

A system and method for analyzing news content is provided. The method includes monitoring a plurality of third party websites; selecting a first news article from a third party website of the plurality of third party website for analysis; analyzing the first news article for a journalistic distortion; assigning a numerical value to the journalistic distortion in each instance of detection of the journalistic distortion; calculating an aggregate numerical value of the journalistic distortion based on a total of the assigned numerical values within the first news article; determining a rating for the first news article using the aggregate numerical value, wherein the rating indicates a level of journalistic distortion contained in the first news article; and providing the rating of the first news article to a user computing device.

### TECHNICAL FIELD

The following relates to a news article rating system, and more specifically to a news rating system and method that analyzes news articles for a level of journalistic distortion.

### BACKGROUND

Many individuals rely on various news and media sources for information. This information may impact the individuals' financial decisions, political beliefs, life choices, etc. While many individuals rely on information from news and media sources to make these decisions, they often fail to realize that news and media content may have incorrect facts, may reach conclusions not supported by the facts, may have their own agenda or bias, may unduly sensationalize facts, may include logical errors, or be incorrect/incomplete for a variety of other reasons. Further, even if individuals do realize that the news and media content include these inaccuracies or deficiencies, individuals may not have an alternative source that is free from these problems. Thus, a news content rating system 100 for news media and related methods would be well received in the art.

### SUMMARY

A first aspect relates generally to a method for analyzing news content, comprising: monitoring, by a processor of a computing system, a plurality of third party websites; selecting, by the processor, a first news article from a third party website of the plurality of third party website for analysis; analyzing, by the processor, the first news article for a journalistic distortion; assigning, by the processor, a numerical value to the journalistic distortion in each instance of detection of the journalistic distortion; calculating, by the processor, an aggregate numerical value of the journalistic distortion based on a total of the assigned numerical values within the first news article; determining, by the processor, a rating for the first news article using the aggregate numerical value, wherein the rating indicates a level of journalistic distortion contained in the first news article; and providing, by the processor, the rating of the first news article to a user computing device.

A second aspect relates generally to computer system, comprising: a processor; a memory device coupled to the processor; and a computer readable storage device coupled to the processor, wherein the storage device contains program code executable by the processor via the memory device to implement a method for analyzing news content, the method comprising: monitoring, by the processor of the computing system, a plurality of third party news websites; selecting, by the processor, a news article from a third party news website from the plurality of news website for analysis; analyzing, by the processor, the news article for a journalistic distortion; assigning, by the processor, a numerical value to the journalistic distortion in each instance of detection of the journalistic distortion; calculating, by the processor, an aggregate numerical value of the journalistic distortion based on a total of the assigned numerical values within the news article; determining, by the processor, a rating for the news article using the aggregate numerical value, wherein the rating indicates a level of journalistic distortion contained in the news article; and providing, by the processor, the rating of the news article to a user computing device.

A third aspect relates generally to computer program product, comprising a computer readable hardware storage device storing a computer readable program code, the computer readable program code comprising an algorithm that when executed by a computer processor of a computing system implements a method for analyzing news content, the method comprising: monitoring, by the processor of the computing system, a plurality of third party news websites; selecting, by the processor, a news article from a third party news website from the plurality of news website for analysis; analyzing, by the processor, the news article for a journalistic distortion; assigning, by the processor, a numerical value to the journalistic distortion in each instance of detection of the journalistic distortion; calculating, by the processor, an aggregate numerical value of the journalistic distortion based on a total of the assigned numerical values within the news article; determining, by the processor, a rating for the news article using the aggregate numerical value, wherein the rating indicates a level of journalistic distortion contained in the news article; and providing, by the processor, the rating of the news article to a user computing device.

### BRIEF DESCRIPTION OF THE DRAWINGS

Some of the embodiments will be described in detail, with reference to the following figures, wherein like designations denote like members, wherein:

FIG. 1 depicts a block diagram of a news content rating system 100, in accordance with embodiments of the present invention;

FIG. 2 depicts a flow chart of a method of rating a level of journalistic distortion in media content, in accordance with embodiments of the present invention; and

FIG. 3 illustrates a block diagram of a computer system for the news content rating system of FIG. 1, capable of implementing the method of rating a level of journalistic distortion in media content of FIG. 2, in accordance with embodiments of the present invention;

FIG. 4 depicts a cloud computing environment, in accordance with embodiments of the present invention; and

FIG. 5 depicts abstraction model layers, in accordance with embodiments of the present invention.

### DETAILED DESCRIPTION

Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure. A more complete understanding of the present embodiments and advantages thereof may be acquired by referring to the following description taken in conjunction with the accompanying drawings, in which like reference numbers indicate like features.

As a preface to the detailed description, it should be noted that, as used in this specification and the appended claims, the singular forms “a”, “an” and “the” include plural referents, unless the context clearly dictates otherwise.

An individual may often desire an indication of whether a news or media content includes journalistic distortion or other inaccuracies. News or media content may include articles, journal entries, photographs, blogs, video clips, audio clips, graphs, and the like. The term news article may be used as an exemplary term below; however, it should be understood that the term news article may also include for example, journal entries, photographs, video clips, audio clips, graphs, and the like. For example, the individual may wish to fact check news content, for example a news article. In a broad sense, the individual may wish to have a sense of the “validity” of the news article or other news or media content from a particular news or media source.

Validity may be determined by quantifying the journalistic distortion present in the news article through a tiered analysis that takes place at different levels of particularity, for example: (1) with respect to each individual word in a news article; (2) with respect to each sentence in a news article; (3) respect to each paragraph or section in a news article; and (4) with respect to the news article in its entirety. The analysis at each level of particularity may identify differing types of journalistic distortion, for example, spin, bias, political leaning, untruths, agenda, slant, logic, influence, juxtaposition, and other types of distortion.

Spin may mean the use of subjective words and opinions that are qualitative and or imprecise; the use of these words often serves to exaggerate certain information or deemphasize certain information. For example, if a news article describes a hurricane as “voracious” the word “voracious” may be an indicator of spin because “voracious” has no precise scientific or quantitative meaning in relation to a hurricane as compared to if the news article described the hurricane as “traveling seventy miles-per-hour” which is a precise quantitative and objective description.

Slant may mean the purposeful selection of certain pieces of information and may be coupled with purposeful omission of other pieces of information.

Logic may refer to whether conclusions are sound, whether an illogical presentation of arguments is being presented as fact, and whether relationships presented between pieces of information are accurate.

Juxtaposition of words, sentences, and paragraphs in a news article may be a factor in determining whether journalistic distortion is present in the news article.

Influence may be an attempt to use particular associations such as persons or other entities to improperly bolster a conclusion or opinion.

Political leaning may mean clear bias toward a certain political party or ideal. It may also refer to characterization of certain ideas, values, or other concepts as “liberal”, “conservative”, “left”, or “right”.

Untruths may be factual assertions that are incorrect or are simply unsupported.

Agenda may refer to a conclusion that the article tends to support but which may not be apparent.

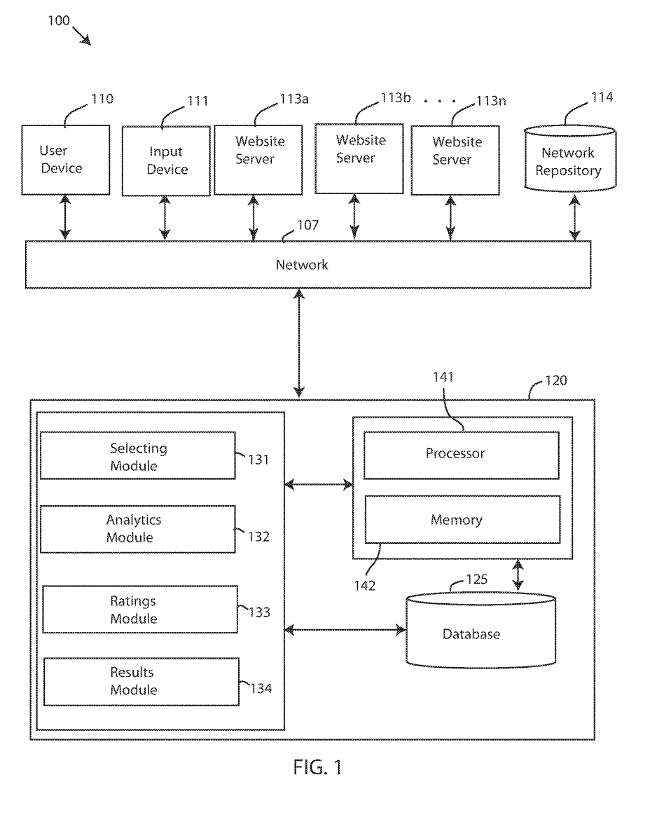

In one embodiment, a news content rating system 100 may include a computing system 120 as shown in FIG. 1 and as will be further described below.

In one embodiment, the news content rating system 100 may include a first tier analysis in which words in a news article are isolated and compared to the words contained in other news articles to determine how many of the words are consistent among the compared news articles.

In one embodiment, the news content rating system 100 may include a specialized dictionary of words aggregated from a plurality of news articles. Such words may also be referred to as keywords. Such words or keywords may be repeatedly used in news media and may be identified as commonly influencing the extent to which a news article is distorted. For example, as described in the example given above, “voracious” may be included in the dictionary as an example of a word that often serves to exaggerate.

Multiple specialized dictionaries may be created for various categories, genres, or types of news media. For example, different dictionaries may be used for political news media than would be used for scientific news media or sports news media. Further, specialized dictionaries may be created for sub-categories, sub-genres, or sub-types of news media. Further sub-sub-categories, sub-sub-genres, and sub-sub-types of news media may be included, and so on as desired. Turning again to the example give above, the word “voracious” may be included as a word showing exaggeration in a political dictionary but may not be included in a dictionary for a category of scientific news media, or in a sub-category regarding zoology, or in a sub-sub-category regarding predatory animals. Embodiments of the specialized dictionary may be a database, such as database 125, a storage device, a cloud storage, and the like, containing one or more words, patterns, categories, keywords, data, information, and phrases.

In one embodiment, the specialized dictionaries may be populated manually, i.e., by having a user input, flag, or otherwise indicate words that should be included. In a further embodiment, the computing system 120 may be configured to automatically populate and update the specialized dictionaries. For example, in one embodiment, the computing system 120 may include algorithms for identifying words, keywords, and/or phrases that should be included. In a further embodiment, the computing system 120 may be configured to actively learn from the words populated into the dictionary manually. For example, after a user begins inputting words into the specialized dictionary, the computing system 120 may select similar words, such as similar parts of speech (i.e., adjectives), synonyms, related words, words that are often used in conjunction with the populated word, etc. In one embodiment, a user may review the populated words and remove, deflag, or otherwise indicate that words should not be included in the specialized dictionary. This action may form a further basis for active learning by the computing system 120, and facilitate determination of which words should be included in the specialize dictionary.

In one embodiment, the first tier analysis may be used to highlight words for the individual, such as words which spin or slant the article, or words that create logical issues with the proposition of the article. The individual may be given the option to receive more details about the highlighted word, such as why it may indicate spin or another journalistic distortion. In one embodiment, commentary may further be presented to the reader explaining how other articles may use the word.

A rating for the news article may be generated based on the first tier analysis. Further, a rating may be generated for each category of journalistic distortion, such as spin, slant, and logic. The rating may indicate the nature or extent of the journalistic distortion.

In another embodiment, the rating system and content generating system may comprise a second tier analysis. The second tier analysis may be used after the first tier analysis, may be triggered when the contents of a news article are such that a rating cannot be determined after undergoing the first tier of analysis alone, or may be used before or alternative to the first tier analysis. The second tier analysis may comprise the analysis of a larger portion of the article than the first tier, i.e., a phrase or a complete sentence. The second tier analysis may analyze the phrase or sentence for spin, slant, logic, and other types of journalistic distortion. Each of the analyses may result in a separate rating of the new article for each of respective slant, spin, logic, and other types of journalistic distortion. The respective ratings of each of slant, spin, logic, and data, or “precedents” and corresponding analyses may then be incorporated into the results of the first tier analysis such that the first tier analysis is updated each time a news article is required to undergo the second tier analysis, and such that subsequent articles may undergo the updated first tier analysis.

The second tier analysis may analyze the entire phrase or sentence for any journalistic distortions. For example, sometimes words that by themselves may not indicate distortion may include distortions when used as a phrase, such as in a figure of speech. Further, the context of the word in the phrase may be important to determine meaning due to the nature of language. For example, sarcasm may not be detectable without analysis of the surrounding word or phrase. Further, logical fallacies may often be analyzed in the context of a phrase or sentence as it may often be impossible to determine if a logical error is made without seeing all premises and the conclusion.

In a yet further embodiment, the news content rating system 100 may comprise a third tier analysis. The third tier analysis may be used in conjunction with the first and second tier analyses, may be used when the contents of a news article are such that a rating cannot be determined after undergoing the first tier of analysis alone, the second tier analysis alone, or the first and second tier analyses together, or may be used as an alternative to the first and second tier analyses. The third tier analysis may comprise the analysis of a larger portion of the article than the first tier and second tier, i.e., a paragraph or section of the article. The third tier analysis may analyze the paragraph or section for spin, slant, logic, and other types of journalistic distortion.

The third tier analysis may analyze entire sections or paragraphs for any journalistic distortions. For example, sometimes sentences that by themselves may not indicate distortion may include distortions when used as part of a larger paragraph. Further, the context of the phrase or sentence may be important to determine meaning due to the nature of language. For example, sarcasm may not be detectable without analysis of the surrounding sentences in the paragraph or section. Further, logical distortions may need to be analyzed in the context of the full paragraph or section as logical conclusions often require detailed premises and preceding conclusions which build upon one another to final ultimate conclusion.

In a yet further embodiment, the news content rating system 100 may comprise a fourth tier analysis. The fourth tier analysis may be used in conjunction with the first, second, and third tier analyses, may be used when the contents of a news article are such that a rating cannot be determined after undergoing the first tier of analysis alone, the second tier analysis alone, the third tier analysis alone, or any combination of the first, second, and third tier analyses together, or may be used as an alternative to the first, second, or third tier analyses. The fourth tier analysis may comprise the analysis of a larger portion of the article than the first, second, or third tier, i.e., the news article in its entirety. The fourth tier analysis may analyze the news article in its entirety for spin, slant, logic, and other types of journalistic distortion.

The fourth tier analysis may analyze the entire news article for any journalistic distortions. For example, sometimes paragraphs or sections that by themselves may not indicate distortion may include distortions when used as part of a larger article. Further, the context of the paragraph or section may be important to determine meaning due to the nature of language. For example, sarcasm or irony may not be detectable without analysis of the surrounding paragraphs in the article. Further, logical distortions may need to be analyzed in the context of the full work as logical conclusions often require detailed premises and preceding conclusions which build upon one another to final ultimate conclusion.

In one embodiment, the news content rating system 100 may provide a rating for the article after performing the analysis described above. The rating may include an overall rating indicating the validity of the article, i.e., the nature and extent of any journalistic distortions. Further, the rating may include sub-ratings for each category of journalistic distortions, such as spin, slant, logic, and the like. Ratings may also be generated for each word, phrase or sentence, and paragraph or section, as well as for the article as a whole.

In a further embodiment, the news content rating system 100 may analyze similar articles and rate them against each other. For example, news sources routinely cover the same “stories” or news. Thus, multiple articles covering the same topic may be generated. The rating system and content generating system 100 may individually analyze and rate each article and then compare the ratings against each other. Further, the news content rating system 100 may analyze and rate the articles compared to each other.

In a further embodiment, the news content rating system 100 may provide a new or rewritten article after analyzing and rating the article. In one embodiment, the news content rating system 100 may create a new article based on one or more articles that have been analyzed and rated as described above. For example, the article may take the highest scoring sections from each article and combine them into a single article. The single article may thus be comprised of the words, phrases or sentences, or sections that would generate the highest possible rating in combination. Alternatively, the news rating and content generating system 100 may generate new words, phrases or sentences, and sections or paragraphs that remove or otherwise address the journalistic distortion found during the analysis. The news content rating system 100 may thus generate a “perfect” article, i.e., on that does not have any journalist distortion.

When the news article comprises an audio or video clip, the news content rating system 100 may generate a transcript of the audio portion. This transcript may be analyzed as has been discussed above. Further, the news content rating system 100 may be configured to analyze audio context as well, such as inflection, tone, pauses, etc. in order to provide more accurate analysis and rating.

The news content rating system 100 may provide a new or rewritten article for an audio or video clip. For example, in one embodiment a new or rewritten transcript may be generated in accordance with the embodiments discussed above. If audio or video is desired, the news content rating system 100 may provide a new or rewritten article may generate a new transcript and subsequently generate the desired audio or video clip using text to audio conversion technology.

Referring again to FIG. 1, a block diagram of a news content rating system 100 is shown, in accordance with embodiments of the present invention. The news content rating system 100 may analyze a news article as has been described above.

In one embodiment, the news content rating system 100 may be executed at least in part by a computing system 120 into which a user may input and manipulate news article sources and rating parameters. In one embodiment, the user may input a news article into a computing system 120 by copying and pasting the internet link for the news article into the processor. Further embodiments of the computing system 120 may monitor third party websites 113a, 113b, . . . 113n and select articles for analysis and provide a user with a level of journalistic distortion for each analyzed article. The computing system 120 may make the ratings available through a mobile software application operating on a mobile device, through a separate website that displays the ratings, or may project/spawn a rating of an article on a page of a website maintained by a third party in which the originally posted/published article exists.

Embodiments of the news content rating system 100 may comprise a user device 110 (and potentially an input device 111 in addition to the user device 110) communicatively coupled to the computer processing system 120 over a network 107. The computer processing system 120 may comprise a processor 141, memory 142, a database 125, a selecting module 131, an analytics module 132, a ratings module 133, and a results module 134. A “module” may refer to a hardware based module, software based module or a module may be a combination of hardware and software. Embodiments of hardware based modules may include self-contained components such as chipsets, specialized circuitry and one or more memory devices, while a software-based module may be part of a program code or linked to the program code containing specific programmed instructions, which may be loaded in the memory device of the computer system 120. A module (whether hardware, software, or a combination thereof) may be designed to implement or execute one or more particular functions or routines.

In one embodiment, the computer system 120 may include the selecting module 131. In one embodiment, the selecting module 131 may include one or more components of hardware and/or software program code for obtaining, retrieving, collecting, identifying or otherwise selecting a news article from one of the plurality of websites. News articles may be identified for analysis by the selecting module 131. For example, in one embodiment, the selecting module 131 may receive a news article from the user or may retrieve an article automatically as is further described. For example, in one embodiment the selecting module 131 may scrape, monitor, scan, access, etc. one or more third party websites 113a, 113b, . . . 113n. In one embodiment, the selecting module 131 may initiate a monitoring and/or scraping process via the communication network 107 based upon specified parameters, for example, date, author, topic, source, and the like. While three third-party websites 113a, 113b, . . . 113n are shown, it should be understood that the system may comprise any number of third-party websites. The scraped news articles undergo a rating process as has been described above. After the news articles have gone through the rating process, the analysis and ratings may be displayed on the user device 110 as has been described. In another embodiment, the selecting module 131 may select a news article from a list of articles provided by a user.

In a further embodiment, the computing system 120 may be configured to access and upload the news article directly from a third-party website via the website link. In another embodiment, the user may enter a news article into the computing system 120 by uploading a text document, video file, audio file, graphical file, etc. from the user device 110. The computing system 120 may be configured to render a scanned news article searchable. The computing system 120 may be configured to transcribe into text a new piece in the form of recorded or streaming audio either from the user device 110 or through an inputted website link.

The user may highlight the portions of a webpage corresponding to the link inputted by the user that comprise the news article the user wishes to have rated. The computing system 120 may be configured to identify the portions of a webpage corresponding to the link inputted by the user that comprise the news article the user wishes to have rated, thereby avoiding the inclusion of extraneous content in the rating analysis, for example, other links present on the page, author name, news article date, and other information. It should be understood that the extraneous information is not limited to being excluded from the rating analysis; for example, in one embodiment, the date of the news article and the news article author name may be components used to compare the validity of the news article to other news articles.

The selecting module 131 may be configured to compile and store all inputted news articles and the ratings received thereby, for example in the database 125. The selecting module 131 may be configured to automatically engage in an news article sweep at a preprogrammed time by accessing third-party news media websites through the network 107 and automatically inputting a pre-determined number of news articles, for example, the news articles appearing on the main page of a website, the first five news articles appearing on a particular page of a website, for example, a page dedicated to news having to do with an election, the news articles on a website having the same author, and the like.

The selecting module 131 may be configured to allow the user to search and compare ratings based upon news article topic, author, country, website, date, and the like. Further, the selecting module 131 may be configured to allow a user to compare news article ratings based upon website, topic, country, and the like. In one embodiment the computing system 120 may be configured to obtain the news articles hosted on the user's chosen news sources. For example, a user that “follows” various news sources on Twitter may synch his or her Twitter “Feed” to the selecting module 131, and the computing system 120 may automatically input the news articles appearing on the user's Twitter Feed and provide a rating for those news articles the user has chosen to select as his or her source of news. The selecting module 131 may be configured to interact with the user's source of news, for example, Twitter Feed, Facebook Timeline, news website, newspaper website, news magazine website, any mobile application versions thereof and the like, such that as the user browses his or her chosen news source(s), the computing system 120 and the selecting module 131 may provide a link or icon through which the user could access the rating and corresponding analysis of news articles directly on the webpage or mobile application of the user's chosen news source.

The computing system 120 and the selecting module 131 may be configured to compile all news articles read by the user in a pre-programmed amount of time, for example, daily, weekly, monthly, and the like, through the user's computer history, Facebook Activity Log, Twitter Feed, and mobile app activity; the computing system 120 may thereafter compile statistical analysis of the ratings of the user's overall news sources and provide the reader with an average rating of all the news articles he or she consumed over the pre-programmed amount of time.

The computing system 120 and the selecting module 131 may be configured to filter news articles out of the user's chosen news source based on the rating of the news article, for example, by removing the news article or link thereto from the news source display viewed by the user, or by visually distinguishing news articles with desired ratings from news articles having less than desirable ratings. The computing system 120 may be configured such that the user can input a rating limit at or above which a news article rating must meet in order to show up in the user's chosen news source.

News articles may be analyzed for journalistic distortion by the analytics module 132 according to the hereinabove description. The analytics module 132 may include one or more components of hardware and/or software program code for evaluating or analyzing the news article. In one embodiment, the analytics module may perform a first tier analysis as has been described above, i.e., analyze each word of the news article for journalistic distortion such as spin, slant, bias, logical fallacies, etc. In further embodiments, second, third, or fourth tier analyses or combinations thereof may be performed by the analytics module 132. In one embodiment, the use of numerical values may be used by the analytics module 132 when analyzing a news article. Numerical values may indicate the extent or nature of the journalistic distortion. For example, use of a slight exaggeration may be assigned a numerical value of 0.5, while a clearly incorrect fact may be given a numerical value of 2. Further, use of a fact without a source may be assigned a numerical value of 1, while use of a statement that is logically contradictory to the rest of the statement may be assigned a numerical value of 5. Various numerical values and ranges thereof may be assigned to various types of journalistic distortion as well as to various extents and severities of the journalistic distortion.

A rating for the news article may be generated by a ratings module 133. The ratings module 133 may include one or more components of hardware and/or software program code for determining a rating from the analysis performed by the analytics module 132. If the news rating and content generating system 100 determines that journalistic distortion is present in the news article, then the system 100 may generate an appropriate rating based on the category or categories of journalistic distortion and the extent of the distortion. In particular, the news content rating system 100 may determine slant, spin, logical issues, and other distortions and the extent of such distortions as has been discussed. For example, in one embodiment, a calculation of the numerical values assigned by the analytics module may be used by the ratings modules to assign a rating to the news article. Numerical values may indicate the extent or nature of the journalistic distortion. For example, use of a slight exaggeration may be assigned a numerical value of 0.5, while a clearly incorrect fact may be given a numerical value of 2. Further, use of a fact without a source may be assigned a numerical value of 1, while use of a statement that is logically contradictory to the rest of the statement may be assigned a numerical value of 5. Various numerical values and ranges thereof may be assigned to various types of journalistic distortion as well as to various extents and severities of the journalistic distortion. In one embodiment, the calculation of the numerical values may involve simple addition of the assigned numerical values. In a further embodiment, the calculation may be more complex. For example, the calculation may weigh various journalistic distortions differently, may weigh the extent of journalistic distortions, may weigh journalistic distortion differently depending on the location of the journalistic distortion within the article (for example, journalistic distortion in the introduction or conclusion may be weighed more heavily as these may tend to impact the user more significantly). In one embodiment, the rating may simply be a reflection of the calculated aggregate numerical value. In a further embodiment, the rating may be based on a conversion of the calculated aggregate numerical value.

A final result may be generated by the results module 134. The results module 134 may include one or more components of hardware and/or software program code for generating a final result from the analysis of the analytics module 132 and the rating of the rating module 133. In one embodiment, the final result may be the display of a report regarding the news articles' rating as determined by the ratings module 133, and/or a more detailed summary of the analysis provided by the analytics module 132. In another embodiment, the final result may be the creation and display of a rewritten article (such as an article having a “perfect” rating or having a maximum possible rating) as has been discussed. In one embodiment, the final result may simply be a presentation of the final rating calculated by the ratings module 133. Additional factors may also be included in the final result, such as whether the article presents good facts or opinions despite the presence of some journalistic distortion. The results module 134 may further categorize the article based on a plurality of thresholds for the rating. For example, a first threshold may indicate that the article is worthless “fake news”. A second threshold may indicate that the article is mostly true. A third threshold may indicate that the article is opinion. Various other thresholds may also be used. Further, the results module 134 may include various other thresholds may be used for different types of journalistic spin or to categorize the article in various ways.

In another embodiment, the computing system 120 and result module 134 may be configured to generate a news article with a “perfect” rating, having no spin, no slant, and no illogical relationships presented as fact. For example, the computing system 120 may be configured to remove these words, phrases, sentences, etc. and insert a factually correct word, phrase sentence, etc., or a words, phrase sentences, etc. that does not include spin, slant, or other journalistic distortion. In another embodiment the computing system 120 may be configured to generate a news article having a maximum possible rating based on the analyzed news articles, as described above. In this embodiment, the computing system 120 may combine the highest scoring words, phrases or sentences, or sections and paragraphs of the analyzed news articles to generate an article having a maximum possible rating.

The ratings and/or the final result may be stored by the computing system 120, for example in the database 125. The ratings and/or the final result may also be sent to the user device 110 (through the network 107) for display or storage. Further, the ratings and/or the final result may be published, for example on a website connected to the computing system 120 by the network 107.

The news content rating system 100 may be configured to store information about the user and the articles read by the user. For example, information may be collected and stored in the network repository 114 and/or the database 125. The collected and stored information may be used by the computing system 120 to determine which articles to automatically scrape for analysis, what sources to choose or prioritize, to generate specialized dictionaries, and the like.

Referring again to FIG. 1, the news content rating system 100 may comprise one or more input devices 111. The number of input devices 111 connecting to computer system 120 over network 107 may vary from embodiment to embodiment, and may be dependent on the user of the user device 110. As shown in FIG. 1, the user device 110 and/or the input device 111 may transmit data, by connecting to computing system 120 over the network 107. A network 107 may refer to a group of two or more computer systems linked together. Network 107 may be any type of computer network known by individuals skilled in the art. Examples of computer networks 107 may include a LAN, WAN, campus area networks (CAN), home area networks (HAN), metropolitan area networks (MAN), an enterprise network, cloud computing network (either physical or virtual) e.g. the Internet, a cellular communication network such as GSM or CDMA network or a mobile communications data network. The architecture of the computer network 107 may be a peer-to-peer network in some embodiments, wherein in other embodiments, the network 107 may be organized as a client/server architecture.

In some embodiments, the network 107 may further comprise, in addition to the computing system 120, user device 110 and input device 111, a connection to one or more network accessible knowledge bases containing information of one or more users, network repositories 114 or other systems connected to the network 107 that may be considered nodes of the network 107. In some embodiments, where the computing system 120 or network repositories 114 allocate resources to be used by the other nodes of the network 107, the computer system 120 and network repository 114 may be referred to as servers.

The network repository 114 may be a data collection area on the network 107 which may back up and save all the data transmitted back and forth between the nodes of the network 107. For example, the network repository 114 may be a data center saving and cataloging user data sent by the mobile device 110 and/or input device 111. In some embodiments, a data collection center housing the network repository 114 may include an analytic module capable of analyzing each piece of data being stored by the network repository 114. Further, the computer system 120 may be integrated with or as a part of the data collection center housing the network repository 114. In some alternative embodiments, the network repository 114 may be a local repository (not shown) that is connected to the computer system 120.

Referring still to FIG. 1, embodiments of the computing system 120 may receive data from the user device 110 and/or input device 111. Input device 111 may be a sensor, an input device, or any input mechanism. For example, input device(s) 111 may be a biometric sensor, a wearable sensor, an environmental sensor, a camera, a camcorder, a microphone, a peripheral device, a computing device, a mobile computing device, such as a smartphone or tablet, facial recognition sensor, voice capture device, and the like. Further embodiments of input device 111 not specifically listed herein may be utilized to collect user data relating to a response to consuming the content of a news article.

Further embodiments of input means 111 may include one or more input devices or input mechanisms, including one or more cameras positioned within an environment shared by the user. The one or more environment cameras may capture image data or video data of user, including a posture, facial expressions, perspiration, muscle activity, gestures, etc. Embodiments of the input device 111 may also include one or more microphones positioned nearby the user to collect audio relating to the user, and other hardware input devices, such as an audio conversion device, digital camera or camcorder, voice recognition devices, graphics tablet, a webcam, VR equipment, mouse, touchpad, stylus, and the like, which may help provide data relating to a consumption by the user of content from a news article.

Furthermore, embodiments of the user device 110 may include a computing device, such as a smartphone or tablet device, associated with or operated by the user. Embodiments of the user device 110 may perform the same functions as described above with respect to the input device 111. The user device 110 may run various applications that contain data about the user. For example, the user device 110 may be used as a sensor, and may also utilize the device's camera, microphone, and other embedded sensors to send information to the computing system 120.

The news content rating system 100 and the user device 110 and input device 111 may be configured to capture data about the user as the user reads a news article, or a response by the user after consuming, reading, understanding, appreciating, etc., the content of the news article. For example, the input device 111 or user device 110 may capture changes in heart rate, blood pressure, breathing, facial expressions, and the like. The input device 111 and the user device 110 may capture emotional responses such as anger, confusion, joy, approval disapproval, and the like. The news content rating system 100 may use the captured data about the user in conjunction with the ratings method described above. For example, the captured data about the user may be used to determine if the news source includes satire (capturing laughter), includes inflammatory language (capturing anger), is logically unclear (capturing confusion or puzzlement), etc.

In another embodiment, the news content rating system 100 may receive and store data regarding the user's reactions to “raw” news articles when compared with the user's reaction to new or rewritten news articles generated by the news content rating system 100. Comparing the user's reaction in this way may be used by the computing system 120 to determine whether new or rewritten news articles are more clear, incite a more neutral reaction (or do not incite any reaction), and the like.

In a still further embodiment, an input mechanism, such as a computing device and/or input device coupled to the computer processing system 120 may be used by a creator/author of the news article. The computer system 120 may collect data about the creator as has been described above. This collected data may be used to analyze the creator's mood or physical condition, as well as other ambient factors such as time of day, location of creation, weather, etc. This collected data may be compared with the ultimate rating of the produced news article. Correlations may be found by the computing system 120 between the collected data and the rating of the created article. For example, it may be determined that the creator is more likely to include journalistic distortion when they are angry, or sad, or when it is late at night, or when the news article is written right before a deadline, or on dreary fall days, etc. The type and prevalence of journalistic distortion may be correlated with a variety of factors.

In one embodiment, the correlation of the collected data with a specific creator's journalistic distortions (or to a more universal prevalence toward a specific distortion under a specific condition) may be used to alert a reader to the likelihood that such a distortion may be encountered.

In a further embodiment, the correlation of the collected data with journalistic distortion may be used alert the creator to the presence of the journalistic distortion. Further, the correlation may be used in a predictive fashion to alert the creator to the likelihood of making such a journalistic distortion given the particular conditions during creation of the article. The computing system 120 may thus be used as an evaluation tool of journalists by the journalist's employer. The employer may be notified that the journalist is often times having to rewrite the article to eliminate journalistic distortions. Alternatively, the computing system 120 may be used as an improvement tool for journalists, to help facilitate a distortionless article. The computing system 120 may set the guidelines with which the journalists must comply, wherein the computing system 120 prevents the journalist from publishing the article on the source's website that is communication with computing system 120.

In a yet further embodiment, the computing system 120 may be configured to prevent the creator from accessing certain programs (such as word processing programs) under certain conditions, such as an emotional state, based on a prevalence of or propensity to include journalistic distortions under the conditions. For example, the computing system 120 may prevent a creator from uploading content when collected data indicates they are upset. As an additional example, the computing system 120 may prevent a creator from editing drafts after a certain time, during a specific event, or when the collected data indicates that the creator is under stress.

FIG. 1 also depicts a news content rating system 100 configured for selecting a news article, for example by scraping third-party websites 113a, 113b, . . . 113n for news articles, analyzing and rating the scraped news articles, and displaying the ratings and analysis on a user device 110. The news content rating system 100 may comprise one or more user devices 110, and a network 107 such as the internet, through which the computing system 120 may communicate with at least one third-party website 113a, 113b, . . . 113n. It should be understood that while one user device 110 is shown in the depicted embodiment, the news content rating system 100 may include multiple user devices 110 in another embodiment. In one embodiment, the computing system 120 may initiate scraping via the communication network 107 based upon specified parameters, for example, date, author, topic, source, and the like. While three third-party websites 113a, 113b, . . . 113n are shown, it should be understood that the system may comprise any number of third-party websites. The scraped news articles undergo a rating process as has been described above. After the news articles have gone through the rating process, the analysis and ratings may be displayed on the user device 110 as has been described.

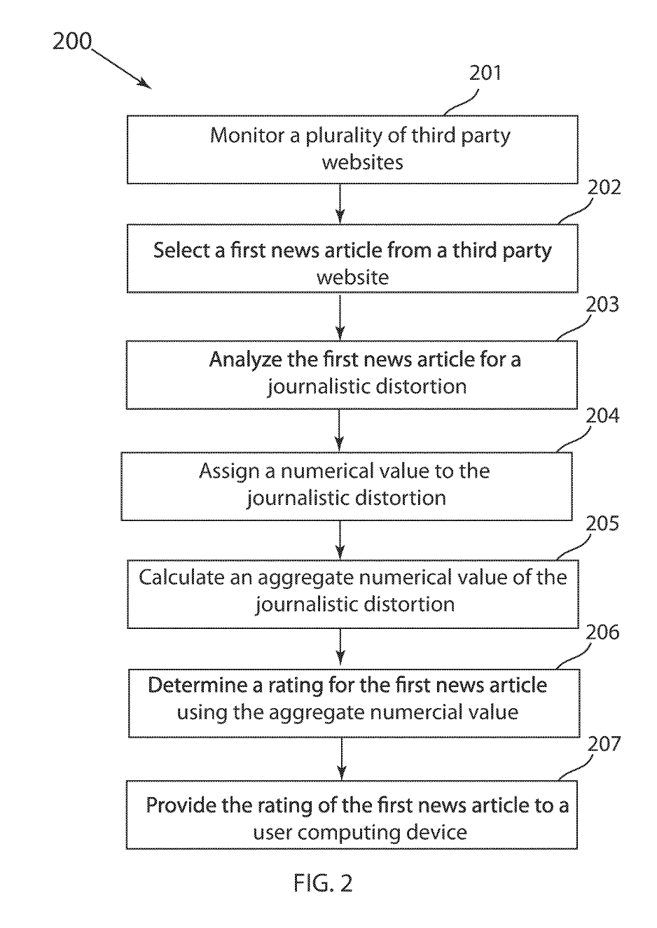

Referring now to FIG. 2, a flow chart for a method of analyzing news content is shown in accordance with one embodiment in which the computing system 120 performs the method steps. Element 201 depicts a method step of monitoring a plurality of third party news websites. The monitoring may step may be a function of a user preference, such as where a user identifies specific websites to be monitored or certain types of websites to be monitored. In another embodiment, the monitoring step may be a function of a determination that specific website is receiving larger than normal traffic or is very popular among internet users at the time.

Element 202 depicts a method step of selecting a first news article from a third party website of the plurality of third party websites. As has been described in further detail above, a news article may include a text article, an audio or video clip, a graphic, etc. In one embodiment, the step of selecting may be based on a user preference, such as a user's indication that they would like the processor to select all articles regarding a specific person, event, time period, by a specific author, etc. Further, the step of selecting may be based on a determination that a specific article is “trending”, i.e., is being viewed by a large number of internet users, is popular, or is “breaking news”, or other similar determinations. In a still further embodiment, the step of selecting may be based on a user selection of a specific article.

Element 203 depicts a method step of analyzing the first news article for a journalistic distortion. Journalistic distortions have been described hereinabove, and may include, for example, spin, slant, a bias, a juxtaposition, a logical fallacy, an unsupported assertion, an influence, a personal anecdote, and the like.

Element 204 depicts a method step of assigning a numerical value to the journalistic distortion in each instance of detection of journalistic distortion found in the step of analyzing the first news article for a journalistic distortion. Numerical values may indicate the extent or nature of the journalistic distortion. For example, use of a slight exaggeration may be assigned a numerical value of 0.5, while a clearly incorrect fact may be given a numerical value of 2. Further, use of a fact without a source may be assigned a numerical value of 1, while use of a statement that is logically contradictory to the rest of the statement may be assigned a numerical value of 5. Various numerical values and ranges thereof may be assigned to various types of journalistic distortion as well as to various extents and severities of the journalistic distortion.

Element 205 depicts a method step of calculating an aggregate numerical value of the journalistic distortion based on a total of the assigned numerical values. In one embodiment, the calculation may involve simple addition of the assigned numerical values. In a further embodiment, the calculation may be more complex. For example, the calculation may weigh various journalistic distortions differently, may weigh the extent of journalistic distortions, may weigh journalistic distortion differently depending on the location of the journalistic distortion within the article (for example, journalistic distortion in the introduction or conclusion may be weighed more heavily as these may tend to impact the user more significantly).

Element 206 depicts a method step of determining a rating for the first news article using the aggregate numerical value, wherein the rating indicates a level of journalistic distortion contained in the first news article. In one embodiment, the rating may simply be a reflection of the calculated aggregate numerical value. In a further embodiment, the rating may be based on a conversion of the calculated aggregate numerical value. Additional factors may also be included in the rating, such as whether the article presents good facts or opinions despite the presence of some journalistic distortion. The news rating and content generating system 100 may categorize the article based on a plurality of thresholds for the rating. For example, a first threshold may indicate that the article is worthless “fake news”. A second threshold may indicate that the article is mostly true. A third threshold may indicate that the article is opinion. Various other thresholds may also be used. Further, thresholds may be used for different types of journalistic spin or to categorize the article in various ways.

Element 207 depicts a method step of providing the rating of the first news article to a user computing device. The step of providing may comprise providing to the user computing device for storage, for display to the user, for use in another application, and the like. A copy of the rating may also be saved in the computing system 120 as is described herein.

Referring again to FIG. 1, in one embodiment, an individual may access the rating and explanation thereof of any news article available from the computing system 120 by activating a news article link displayed on the user device 110 when the user device 110 is operable connected to the computing system 120 through the network 107 (i.e., to a website through the internet). The computing system 120 may further be configured to display (by sending to the user device 110 through the network 107) comparative ratings of different news sources' coverage of the same event, when news articles are rated in comparison as has been described above.

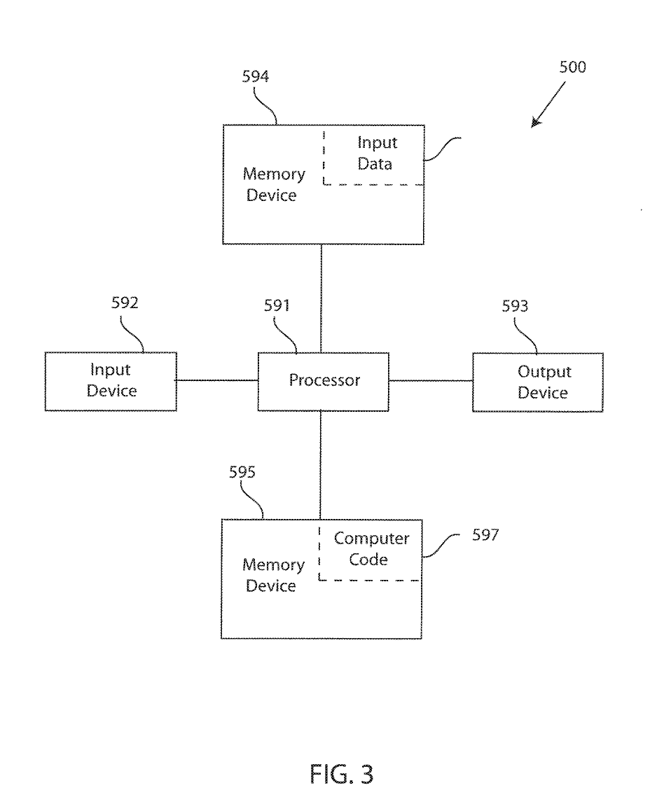

FIG. 3 illustrates a block diagram of a computer system 500 that may be included in the system of FIG. 1 and for implementing the method of FIG. 2 in accordance with the embodiments of the present disclosure. The computer system 500 may generally comprise a processor 591, an input device 592 coupled to the processor 591, an output device 593 coupled to the processor 591, and memory devices 594 and 595 each coupled to the processor 591. The input device 592, output device 593 and memory devices 594, 595 may each be coupled to the processor 591 via a bus. Processor 591 may perform computations and control the functions of computer 500, including executing instructions included in the computer code 597 for the tools and programs capable of implementing a method prescribed by the embodiments of FIG. 3 and the system of FIG. 1, wherein the instructions of the computer code 597 may be executed by processor 591 via memory device 595. The computer code 597 may include software or program instructions that may implement one or more algorithms for implementing the methods described in detail above. The processor 591 executes the computer code 597. Processor 591 may include a single processing unit, or may be distributed across one or more processing units in one or more locations (e.g., on a client and server).

The memory device 594 may include input data 596. The input data 596 includes any inputs required by the computer code 597. The output device 593 displays output from the computer code 597. Either or both memory devices 594 and 595 may be used as a computer usable storage medium (or program storage device) having a computer readable program embodied therein and/or having other data stored therein, wherein the computer readable program comprises the computer code 597. Generally, a computer program product (or, alternatively, an article of manufacture) of the computer system 500 may comprise said computer usable storage medium (or said program storage device).

Memory devices 594, 595 include any known computer readable storage medium, including those described in detail below. In one embodiment, cache memory elements of memory devices 594, 595 may provide temporary storage of at least some program code (e.g., computer code 597) in order to reduce the number of times code must be retrieved from bulk storage while instructions of the computer code 597 are executed. Moreover, similar to processor 591, memory devices 594, 595 may reside at a single physical location, including one or more types of data storage, or be distributed across a plurality of physical systems in various forms. Further, memory devices 594, 595 can include data distributed across, for example, a local area network (LAN) or a wide area network (WAN). Further, memory devices 594, 595 may include an operating system (not shown) and may include other systems not shown in FIG. 6.

In some embodiments, the computer system 500 may further be coupled to an Input/output (I/O) interface and a computer data storage unit. An I/O interface may include any system for exchanging information to or from an input device 592 or output device 593. The input device 592 may be, inter alia, a keyboard, a mouse, etc. or in some embodiments the sensors 110. The output device 593 may be, inter alia, a printer, a plotter, a display device (such as a computer screen), a magnetic tape, a removable hard disk, a floppy disk, etc. The memory devices 594 and 595 may be, inter alia, a hard disk, a floppy disk, a magnetic tape, an optical storage such as a compact disc (CD) or a digital video disc (DVD), a dynamic random access memory (DRAM), a read-only memory (ROM), etc. The bus may provide a communication link between each of the components in computer 500, and may include any type of transmission link, including electrical, optical, wireless, etc.

An I/O interface may allow computer system 500 to store information (e.g., data or program instructions such as program code 597) on and retrieve the information from computer data storage unit (not shown). Computer data storage unit includes a known computer-readable storage medium, which is described below. In one embodiment, computer data storage unit may be a non-volatile data storage device, such as a magnetic disk drive (i.e., hard disk drive) or an optical disc drive (e.g., a CD-ROM drive which receives a CD-ROM disk). In other embodiments, the data storage unit may include a knowledge base or data repository 125 as shown in FIG. 1.

As will be appreciated by one skilled in the art, in a first embodiment, the present invention may be a method; in a second embodiment, the present invention may be a system; and in a third embodiment, the present invention may be a computer program product. Any of the components of the embodiments of the present invention can be deployed, managed, serviced, etc. by a service provider that offers to deploy or integrate computing infrastructure with respect to calendar management systems and methods. Thus, an embodiment of the present invention discloses a process for supporting computer infrastructure, where the process includes providing at least one support service for at least one of integrating, hosting, maintaining and deploying computer-readable code (e.g., program code 597) in a computer system (e.g., computer 500) including one or more processor(s) 591, wherein the processor(s) carry out instructions contained in the computer code 597 causing the computer system to rate news content. Another embodiment discloses a process for supporting computer infrastructure, where the process includes integrating computer-readable program code into a computer system including a processor.

The step of integrating includes storing the program code in a computer-readable storage device of the computer system through use of the processor. The program code, upon being executed by the processor, implements a method of rating news content. Thus, the present invention discloses a process for supporting, deploying and/or integrating computer infrastructure, integrating, hosting, maintaining, and deploying computer-readable code into the computer system 500, wherein the code in combination with the computer system 500 is capable of performing a method for rating news content.

A computer program product of the present invention comprises one or more computer readable hardware storage devices having computer readable program code stored therein, said program code containing instructions executable by one or more processors of a computer system to implement the methods of the present invention.

A computer system of the present invention comprises one or more processors, one or more memories, and one or more computer readable hardware storage devices, said one or more hardware storage devices containing program code executable by the one or more processors via the one or more memories to implement the methods of the present invention.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

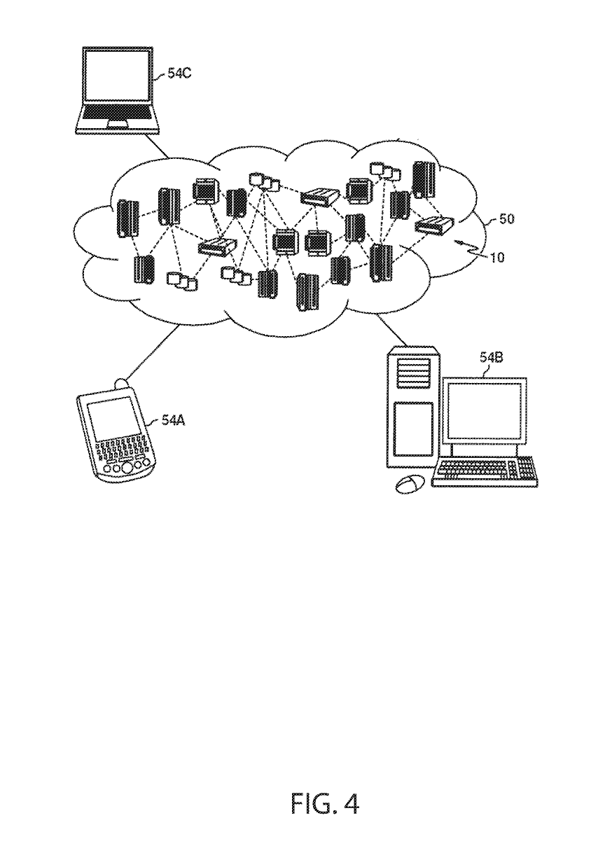

Referring now to FIG. 4, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, and/or laptop computer 54C may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A, 54B, and 54C shown in FIG. 4 are intended to be illustrative only and that computing nodes 10 and cloud computing environment 50 can communicate with any type of computerized device over any type of network and/or network addressable connection (e.g., using a web browser).

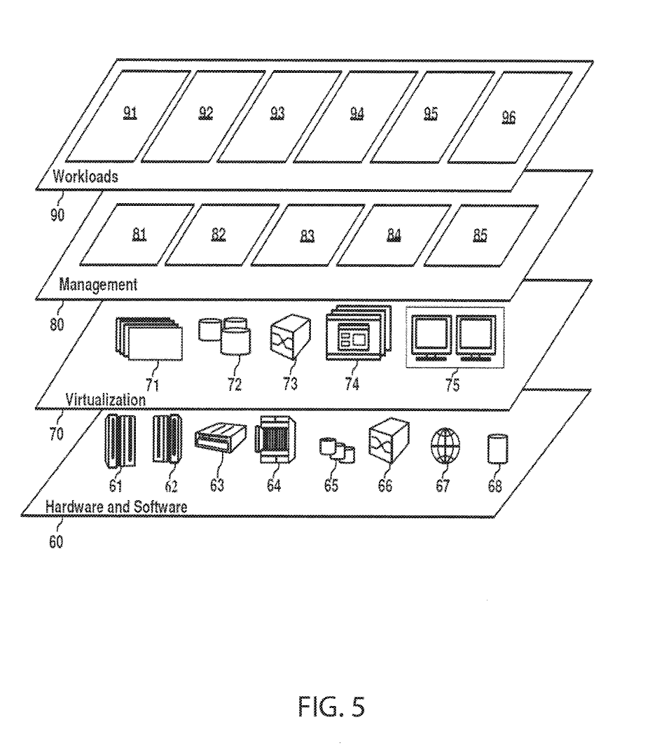

Referring now to FIG. 5, a set of functional abstraction layers provided by cloud computing environment 50 (see FIG. 4) is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: selecting a news article 91; analyzing a news article 92; rating a news article 93; generating results about the analyzing and rating 94; collecting data about a user 95; generating a new or rewritten article 96, etc.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for analyzing news content, comprising:
monitoring, by a processor of a computing system, a plurality of third party websites;
selecting, by the processor, a first news article from a third party website of the plurality of third party website for analysis;
analyzing, by the processor, the first news article for a journalistic distortion;
assigning, by the processor, a numerical value to the journalistic distortion in each instance of detection of the journalistic distortion;
calculating, by the processor, an aggregate numerical value of the journalistic distortion based on a total of the assigned numerical values within the first news article;
determining, by the processor, a rating for the first news article using the aggregate numerical value, wherein the rating indicates a level of journalistic distortion contained in the first news article; and
providing, by the processor, the rating of the first news article to a user computing device.

2. The method of claim 1, wherein the selecting is based on at least one of a user preference, a preselected category, a determination that an article is “trending”, and a user selection.

3. The method of claim 1, wherein the analyzing includes detecting, by the processor, one or more keywords in the first news article that are associated with the journalistic distortion.

4. The method of claim 1, wherein the analyzing includes at least one of analyzing each word of the first news article, analyzing each sentence of the first news article, analyzing each paragraph of the first news article, and analyzing the entire first news article.

5. The method of claim 4, wherein the analyzing includes at least two of analyzing each word of the first news article, analyzing each sentence of the first news article, analyzing each paragraph of the first news article, and analyzing the entire first news article.

6. The method of claim 1, wherein the journalistic distortion includes at least one of a slant, a bias, a spin, a logical fallacy, an influence, a personal anecdote, a juxtaposition.

7. The method of claim 1, wherein the rating is determined by comparing the aggregate numerical value to a plurality of thresholds.

8. The method of claim 7, wherein the plurality of thresholds includes at least one of fake news, opinion piece, mostly fact, and fact.

9. The method of claim 1, further comprising:
generating, by the processor, a second news article, wherein the second news article is based on the first news article, further wherein the processor has removed the journalistic distortion from the first news article to create the second news article.

10. The method of claim 1, wherein the analyzing includes verifying a fact with at least four sources.

11. A computer system, comprising:
a processor;
a memory device coupled to the processor; and
a computer readable storage device coupled to the processor, wherein the storage device contains program code executable by the processor via the memory device to implement a method for analyzing news content, the method comprising:
monitoring, by the processor of the computing system, a plurality of third party news websites;
selecting, by the processor, a news article from a third party news website from the plurality of news website for analysis;
analyzing, by the processor, the news article for a journalistic distortion;
assigning, by the processor, a numerical value to the journalistic distortion in each instance of detection of the journalistic distortion;
calculating, by the processor, an aggregate numerical value of the journalistic distortion based on a total of the assigned numerical values within the news article;
determining, by the processor, a rating for the news article using the aggregate numerical value, wherein the rating indicates a level of journalistic distortion contained in the news article; and
providing, by the processor, the rating of the news article to a user computing device.

12. The computer system of claim 11, wherein the selecting is based on at least one of a user preference, a preselected category, a determination that an article is “trending”, and a user selection.

13. The computer system of claim 11, wherein the analyzing includes detecting, by the processor, one or more keywords in the news articles that are associated with the journalistic distortion.

14. The computer system of claim 11, wherein the analyzing includes at least one of analyzing each word of the news article, analyzing each sentence of the news article, analyzing each paragraph of the news article, and analyzing the entire news article.

15. The computer system of claim 14, wherein the analyzing includes at least two of analyzing each word of the news article, analyzing each sentence of the news article, analyzing each paragraph of the news article, and analyzing the entire news article.

16. The computer system of claim 11, wherein the journalistic distortion includes at least one of a slant, a bias, a spin, a logical fallacy, an influence, a personal anecdote, a juxtaposition.

17. The computer system of claim 11, wherein the rating is determined by comparing the aggregate numerical value to a plurality of thresholds.

18. The computer system of claim 17, wherein the plurality of thresholds includes at least one of fake news, opinion piece, mostly fact, and fact.

19. The method of claim 11, further wherein comprising:
generating, by the processor, a second news article, wherein the second news article is based on the first news article, further wherein the processor has removed the journalistic distortion from the first news article to create the second news article.

20. The method of claim 11, wherein the analyzing includes verifying a fact with at least four sources.

21. A computer program product, comprising a computer readable hardware storage device storing a computer readable program code, the computer readable program code comprising an algorithm that when executed by a computer processor of a computing system implements a method for analyzing news content, the method comprising:
monitoring, by the processor of the computing system, a plurality of third party news websites;
selecting, by the processor, a news article from a third party news website from the plurality of news website for analysis;
analyzing, by the processor, the news article for a journalistic distortion;
assigning, by the processor, a numerical value to the journalistic distortion in each instance of detection of the journalistic distortion;
calculating, by the processor, an aggregate numerical value of the journalistic distortion based on a total of the assigned numerical values within the news article;
determining, by the processor, a rating for the news article using the aggregate numerical value, wherein the rating indicates a level of journalistic distortion contained in the news article; and
providing, by the processor, the rating of the news article to a user computing device.
